(19) United States
(12) Patent Application Publication
(10) Pub. No.: US 2012/0012197 A1
(43) Pub. Date: Jan. 19, 2012

(54) VALVE FOR CONTROLLING AMOUNT OF WATER IN RIM-SIDE SUPPLY PIPE OF FILL VALVE IN WATER TOILET

(75) Inventor: Tae Gwang Song, Gimpo-si (KR)

(73) Assignee: WATOS COREA CO., LTD., Incheon-si (KR)

(21) Appl. No.: 13/259,778

(22) PCT Filed: Jan. 11, 2010
(86) PCT No.: PCT/KR2010/000159

§ 371 Date: Sep. 23, 2011

(30) Foreign Application Priority Data
Mar. 31, 2009 (KR) 10-2009-0027782

(51) Int. Cl. F16K 31/18

(52) U.S. Cl. 137/409

(57) ABSTRACT

A valve for controlling the amount of water in a rim-side supply pipe of a fill valve in a water toilet. The valve includes a fill valve for permitting and stopping supply of washing water from a hydrant into a water tank. A fixing section fixes the fill valve to an overflow pipe. A float has a packing for opening or closing an opening/closing hole of the fill valve depending on a level of water contained in the water tank. A water amount control valve controls the amount of washing water which is supplied to the rim-side supply pipe of the fill valve. The amount of washing water, which is supplied toward a rim of the toilet, is controlled by the opened area of the rim-side supply pipe of the fill valve.

### TECHNICAL FIELD

The present invention relates, in general, to a fill valve in a water toilet, in which washing water supplied from a hydrant is efficiently supplied to a water tank and a toilet body, and, more particularly, to a valve for controlling the amount of water in a rim-side supply pipe of a fill valve in a water toilet, in which the amount of washing water, which is supplied toward a rim of the toilet, is controlled by the opened area of the rim-side supply pipe of the fill valve.

### BACKGROUND ART

A water toilet, which is generally installed in a bathroom or a restroom, is equipped with a toilet body on which a user can sit to relieve him/herself. A water tank is provided behind the toilet body and contains washing water which drains excrement from the toilet body into a water-purifier tank.

When a drain hole is opened following the rotation of a control valve, washing water is discharged through the drain hole. As the level of water in the water tank goes down, washing water supplied from a hydrant to the fill valve is supplied into the water tank through a water tank-side supply pipe and also toward a rim of the toilet body through a rim-side supply pipe, thereby washing the excrement in the toilet body.

An apparatus for controlling washing water, which is supplied from the hydrant, to be supplied to the water tank-side supply pipe and the rim-side supply pipe is disclosed in Korean Registered Utility Model No. 338316 (Application No. 2003-31855) granted to the applicant, entitled “Apparatus for Controlling Washing Water in Water Toilet.”

In the registered utility model, a control section moves up and down along a guide section depending on the level of washing water, which is contained in a water tank, to control the rotation of a reversing lever. When the level of the washing water is low, water supplied from the hydrant is supplied to the rim-side supply pipe. When the level of the washing water is high, water is supplied to the water tank-side supply pipe.

However, in this registered utility model, the structure for supplying washing water from the hydrant to the rim-side supply pipe and the water tank-side supply pipe is complicated, thereby decreasing productivity and increasing manufacturing cost.

In addition, it is impossible to control the amount of washing water, which is supplied toward the rim-side supply pipe. Consequently, washing water is unnecessarily discharged and thus wasted, thereby causing an economical problem.

### DISCLOSURE

### Technical Problem

Accordingly, the present invention has been made keeping in mind the above problems occurring in the related art, and is intended to provide a valve for controlling the amount of water in a rim-side supply pipe of a fill valve in a water toilet, which ensures that washing water supplied from a hydrant be efficiently supplied to a rim-side supply pipe and a water tank-side supply pipe, and has a simplified structure, thereby improving productivity and reducing manufacturing cost.

Further, the present invention serves to provide a valve for controlling the amount of water in a rim-side supply pipe of a fill valve in a water toilet, which can control the amount of washing water supplied to the rim-side supply pipe in order to decrease the amount of washing water, which is unnecessarily discharged, thereby decreasing the amount of washing water that is wasted and improving economical efficiency.

### Technical Solution

In an aspect, the present invention provides an valve for controlling an amount of water in a rim-side supply pipe of a fill valve in a water toilet, including a fill valve for permitting and stopping supply of washing water from a hydrant into a water tank; a fixing section fixing the fill valve to an overflow pipe; a float having a packing, the packing opening or closing an opening/closing hole of the fill valve depending on a level of water contained in the water tank; and a water amount control valve for controlling an amount of washing water which is supplied to the rim-side supply pipe of the fill valve.

### Advantageous Effects

The valve for controlling the amount of water in a rim-side supply pipe of a fill valve in a water toilet according to the present invention has a simplified structure so that washing water supplied from the hydrant can be efficiently supplied to the rim-side supply pipe and the water tank-side supply pipe, thereby improving productivity and reducing the manufacturing cost.

The valve for controlling the amount of water in a rim-side supply pipe of a fill valve in a water toilet according to the present invention allows the amount of washing water supplied to the rim-side supply pipe to be controlled so that the amount of washing water, which is unnecessarily discharged, can be decreased, so that less washing water is wasted and economical efficiency is improved.

### DESCRIPTION OF DRAWINGS

FIG. 1 is a perspective view of the present invention;

FIG. 2 is an exploded perspective view of the present invention;

FIG. 3 is a cross-sectional view of the present invention;

FIG. 4 is a view showing the state of installation of the present invention; and

FIG. 5 and FIG. 6 are views showing the states in which the present invention operates.

### MAJOR REFERENCE NUMERALS OF THE DRAWINGS

100: apparatus for preventing backflow

110: fill valve

120: fixing section

130: float

140: water quantity control valve

141: socket member

142: area adjustment member

142′: passage space

### MODE FOR INVENTION

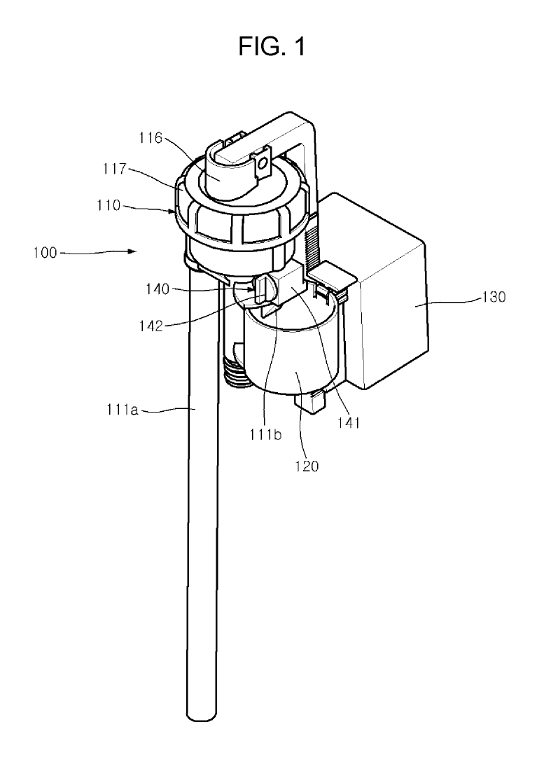

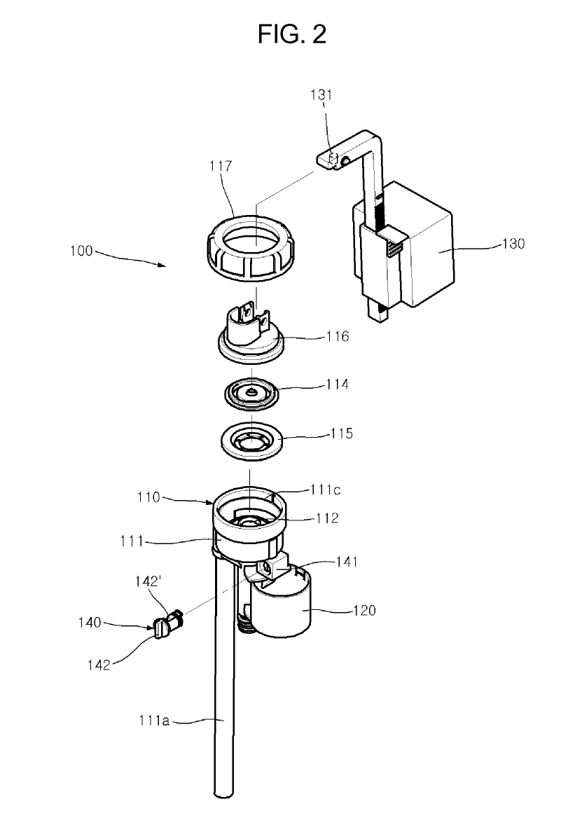

Hereinafter an embodiment of the present invention will now be described in detail with reference to the accompanying drawings. FIG. 1 is a perspective view of the present invention, and FIG. 2 is an exploded perspective view of the present invention.

A valve for controlling the amount of water in a rim-side supply pipe of a fill valve in a water toilet includes a fill valve 110, a fixing section 120, a float 130, and a water amount control valve 140. The fill valve 110 permits and stops the supply of washing water, which is supplied from a hydrant into a water tank, to a water tank-side supply pipe 111a and a rim-side supply pipe 111b. The fixing section 120 fixes the fill valve 110 to an overflow pipe 20. The float 130 has a packing 131, which opens and closes an opening/closing hole 116a of the fill valve 110 depending on the level of water, which is contained in the water tank 10. The water amount control valve 140 controls the amount of washing water that is supplied to the rim-side supply pipe 111b of the fill valve 110. The following is a more in-depth description of these.

The water amount control valve 140 includes a socket member 141, which is disposed to communicate with the rim-side supply pipe 111b of the fill valve 110. An area adjustment member 142 is coupled to the socket member 141 to adjust the area of opening of the rim-side supply pipe 111b.

It is preferable that the area adjustment member 142 be rotatably coupled with the socket member 141.

A passage space 142′ is recessed inwards from the outer circumference of the area adjustment member 142 to guide the flow of washing water.

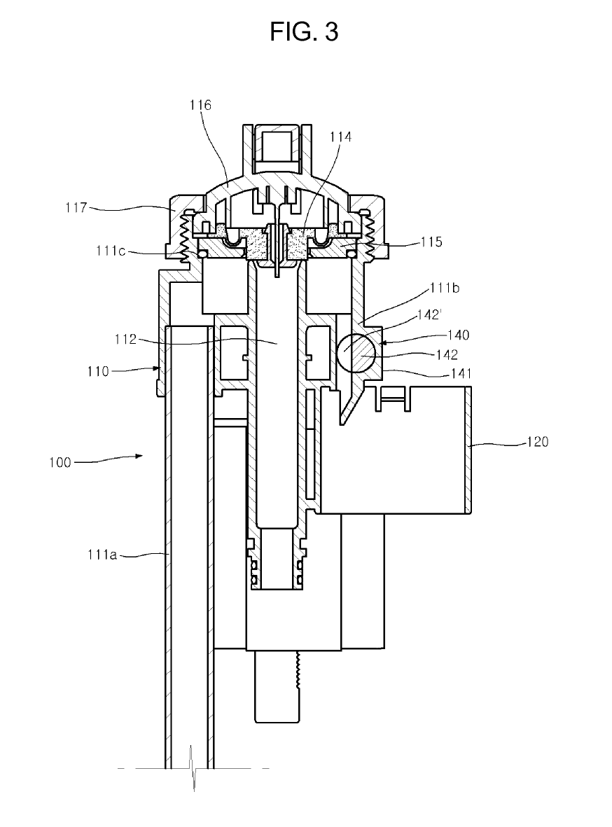

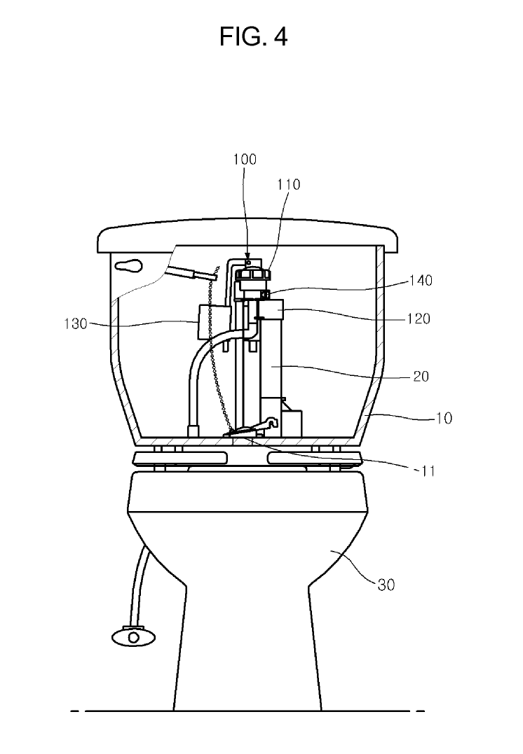

A description is given below of the process of assembling and installing the fill valve 110 of the present invention. First, as shown in FIG. 3 and FIG. 4, a support member 115 is seated on a fitting protrusion 111c of a valve body 111 of the fill valve 110, and a water supply valve 114 is seated on the support member 115. In this state, a cap 116 is seated on the water supply valve 114. Afterwards, a fastening member 117, which receives the cap 116, is fixedly fastened to the valve body 111.

In addition, the packing 131, which serves to open and close the opening/closing hole 116a of the cap 116, is disposed inside the float 130, and is rotatably mounted to the cap 116. The packing 131 is also formed integrally with the valve body 111 so that the rim-side supply pipe 11b of the fill valve 110 and the socket member 141 of the water amount control valve 140 communicate with each other. The area adjustment member 142 is rotatably mounted to the socket member 141. It is preferable that an O-ring (not shown) be disposed between the socket member 141 and the area adjustment member 142 to prevent washing water from leaking.

The installation of the fill valve 110 is completed by fixedly mounting the fixing section 120 to the overflow pipe 20 when the hydrant is in the state of being connected to the supply pipe 112 of the fill valve 110 to which the float 130 and the water amount control valve 140 are coupled.

A description is given below of the fill valve 110, which is installed as above. When a user manipulates an operation lever (not shown) after having relieved him/herself, a siphon cover (not shown) is rotated upwards to open a drain hole 11 of the water tank 10. Then, wash water contained in the water tank 10 is discharged through the opened drain 11 into a toilet body 30, thereby washing away and discharging excrement into a water-purifier tank.

As the level of water is lowered in response to the discharge of washing water through the drain hole 11, the float 130 is rotated downwards about the cap 116, so that the packing 131 of the float 130 opens the opening/closing hole 116a of the cap 116. Then, washing water that was between the water supply valve 114 and the cap 116 is discharged into the water tank 10 through the opening/closing hole 116a so that the force supporting the water supply valve 114 is lost.

Here, the water supply valve 114, which has lost the supporting force, is moved upwards by the hydraulic pressure of washing water, which is being supplied from the hydrant into the supply pipe 112, through the inside of the cap 116 so as to open the supply pipe 112. Washing water, which is discharged through the opened supply pipe 112, is mostly supplied to the water tank-side supply pipe 111a and the rim-side supply pipe 111b, but is partially supplied to between the water supply valve 114 and the cap 116 through a through-hole (not shown) of the water supply valve 114.

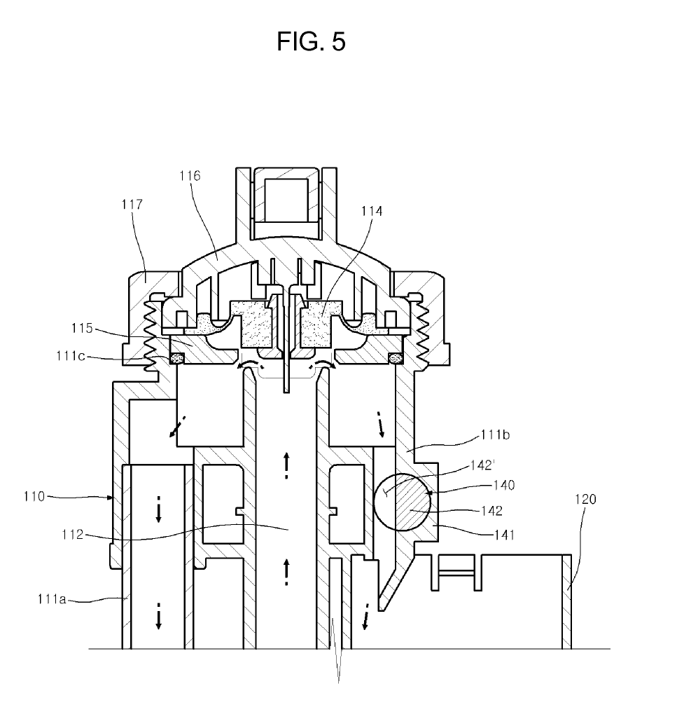

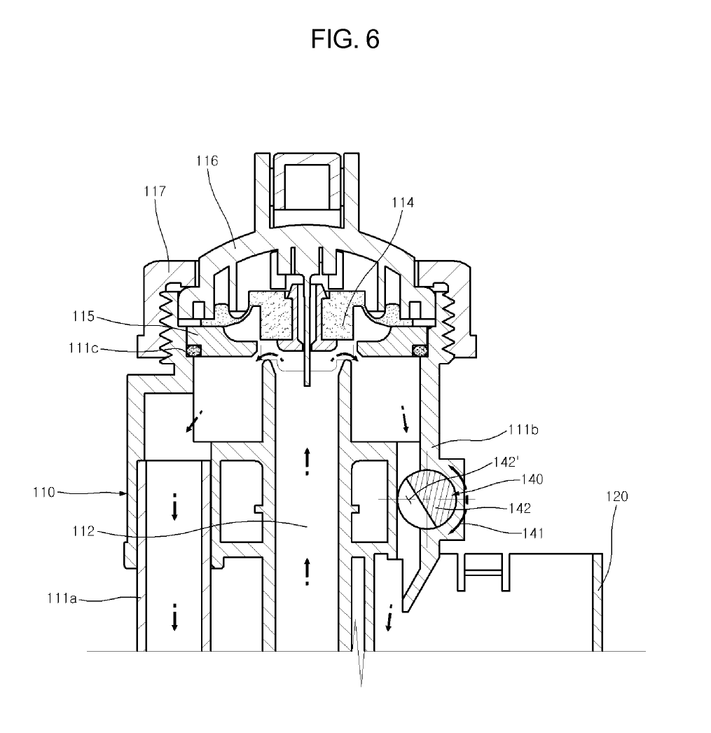

Here, as shown in FIG. 5 and FIG. 6, washing water supplied to the rim-side supply pipe 111b can adjust the area of opening of the rim-side supply pipe 111b by rotating the area adjustment member 142 of the water amount control member 140 inside the socket member 141. This process adjusts the area of opening of the rim-side supply pipe 111b, and washing water supplied to the rim-side supply pipe 111b is then supplied toward the rim of the toilet body 30 via the passage space 142′ of the area adjustment member 142.

The foregoing process makes it possible to control washing water, which is supplied toward the rim of the toilet body 30, thereby preventing an unnecessary excess of water from being supplied and wasted. In addition, it is also possible to easily wash the excrement in the toilet body 30 using washing water which is supplied toward the rim as well as washing water which is supplied to the water tank-side supply pipe 111a and is then discharged through the drain hole 11.

Although the present invention has been described with reference to the certain embodiments and the drawings, the terms and words used in the disclosure and accompanying claims are by no means limited to typical or literal meanings thereof but should be interpreted as meanings and concepts that coincide with the technical principle of the present invention. Therefore, the foregoing embodiments described in the specification and illustrated in the drawings are merely an example of the present invention, but do not embrace all the technical principles of the present invention. It should also be understood that various equivalents and alterations can be made without departing from the scope of the accompanying claims.

1. A valve for controlling an amount of water in a rim-side supply pipe of a fill valve in a water toilet, comprising:
a fill valve for permitting and stopping supply of washing water from a hydrant into a water tank;
a fixing section fixing the fill valve to an overflow pipe;
a float having a packing, the packing opening or closing an opening/closing hole of the fill valve depending on a level of water contained in the water tank; and
a water amount control valve for controlling an amount of washing water which is supplied to the rim-side supply pipe of the fill valve.

2. The valve of claim 1, wherein the water amount control valve comprises:
a socket valve disposed to communicated with the rim-side supply pipe of the fill valve; and
an area adjustment member coupled to the socket member, wherein the area adjustment member adjusts an area of opening of the rim-side supply pipe.

3. The valve of claim 2, wherein the area adjustment member is rotatably coupled to the socket member.

4. The valve of claim 2, wherein a passage space is recessed inwards from an outer circumference of the area adjustment member to guide a flow of washing water.

5. The valve of claim 3, wherein a passage space is recessed inwards from an outer circumference of the area adjustment member to guide a flow of washing water.
